(19) United States
(12) Patent Application Publication
(10) Pub. No.: US 2014/0253785 A1
(43) Pub. Date: Sep. 11, 2014

(54) Auto Focus Based on Analysis of State or State Change of Image Content

(71) Applicant: MEDIATEK INC., Hsin-Chu (TW)

(72) Inventors: Wei-Kai Chan, Yilan (TW); Yuan-Chung Lee, Tainan (TW); Chen-Hung Chan, Taoyuan (TW)

(73) Assignee: MEDIATEK INC., Hsin-Chu (TW)

(21) Appl. No.: 13/788,311

(22) Filed: Mar. 7, 2013

(51) Int. Cl. H04N 5/232

(52) U.S. Cl. CPC H04N 5/23212
USPC 348/349

(57) ABSTRACT

A method and apparatus of auto focusing for a camera based on analysis of the image content in a target window are disclosed. According to the present invention, image content in a target window is analyzed to determine a state, a state change or both associated with the target window. The information associated with the state, the state change or both is provided to update the camera parameters. The state may be size, position, pose, behavior or gesture of one or more objects, or areas associated with one or more regions in the target window. The state may correspond to the motion field or optical flow associated with the target window. The state may correspond to object motion, extracted features or scales of the objects in the target window. The state may correspond to image content description of the segmented regions or deformable object contour in the target window.

### FIELD OF THE INVENTION

The present invention relates to auto focus. In particular, the present invention relates to an auto focus method that is capable of updating camera parameters based on the analysis of a state, a change of the state or both of the state and the change of the state related to a target window in a camera view.

### BACKGROUND

Auto focus technology has been widely adopted in video camera systems to enable fully automatic focus on a point or region of interest, which can be selected either automatically or manually. Auto focus (hereinafter referred to as AF) is usually performed by half-pressing the shoot button or manually selecting a point or region from a touch screen. AF technology helps to provide accurate focusing on objects of interest quickly without much manual intervention, thus is considered to be a very convenient feature for photographers.

Objects to be photographed or video recorded by a camera may move to any direction in relation to the camera. This relative movement may impose special difficulty for the AF to focus on a target point or region accurately, especially when AF need to be performed continuously. Thus the AF technology has been enhanced to incorporate an object tracking method that tracks an interest region and automatically focus on the selected region from the camera view, which usually contains a portion of predetermined object by a camera operator. From the camera operator's perspective, such a system is capable of continuously tracking an object after half-pressing the shoot button or selecting the object from a touch screen. Picture quality and rate of successful image taking can be significantly improved by incorporating the object tracking method.

FIG. 1 illustrates an exemplary block diagram of traditional auto focus method using object tracking When a camera operator selects a target object to be photographed and when the object tracking function is turned on, a target window is extracted from its background by object tracking 110 and provided to AF algorithm 120 for adjusting focus.

In conventional object tracking methods, an object tracking algorithm extracts the target window for the object of interest from the image and calculates the target window for the AF algorithm to control focusing. Then the AF performs scan and search based on the target window information to find the focus peak (or focus position). This process can be slow due to the nature of searching for optimal focus point which usually involves mechanical adjustment in the optical subsystem. It may also fail to track the object when relative movement between object and camera is faster than the focus peak searching process can respond. Fast moving objects can also lead to blurred image, which in turn may result in errors in object tracking and degraded performance of AF. Therefore it is desirable to improve the performance of object tracking methods by providing better information for the AF algorithm to search for focus peak thus reducing the time needed to find focus peak or getting better quality pictures.

### BRIEF SUMMARY OF THE INVENTION

One object of the present invention is to provide an AF method to improve the speed or quality of focusing by updating camera parameters based on a state, a state change or both the state and the state change in a target window. A method incorporating an embodiment of the present invention comprises the steps of: receiving an input image formed by an optical subsystem of the camera; selecting a target window corresponding to image content of interest in the input image; determining a state, a change of the state, or both of the state and the change of the state related to the target window; and updating one or more camera parameters based on the state, the change of the state, or both of the state and the change of the state related to the target window.

One aspect of the present invention addresses types of state that can be used for camera focus control. The state can be the size, position, or pose of one or more objects in the target window. The state can also be the behavior or gesture of one or more objects in the target window. The behavior or gesture comprises movement direction, body rotating, turning around and shaking hand. The state can also correspond to the area of one or more regions associated with the target window or associated with one or more objects in the target window. The state can correspond to object motion associated with one or more object in the target window, or the motion field or optical flow associated with the target window. The state can correspond to features extracted from the target window or scales associated with one or more objects in the target window. The state can correspond to the description of the image content of interest derived from the target window, or one or more segmented regions or deformable object contour associated with the target window.

According to one embodiment of the current invention, the state, the state change or both provides search direction and number of focusing steps for AF. If the state, the state change or both indicates that the object(s) in the target window is moving toward the camera, the camera focus is updated toward Macro. On the other hand, if the state, the state change or both indicates that the object(s) in the target window is moving away from the camera, the camera focus is updated toward Infinity. Number of focusing steps can also be determined by the change size associated with the state, the state of change or both.

### BRIEF DESCRIPTION OF THE DRAWINGS

FIG. 1 illustrates an exemplary block diagram of traditional auto focus method using object tracking.

FIG. 2 illustrates an exemplary block diagram of auto focus method according to the present invention, wherein the information based on analysis of the image content in the target window is also used for AF control.

FIG. 3 illustrates an exemplary flow chart of an auto focus method according to one embodiment of the present invention which provides the information associated with a state, a change of the state or both related to a target for AF.

FIG. 4 illustrates an example of the size change of one or more objects in a target window which indicates the object of interest is moving closer.

FIG. 5 illustrates an example of the size change of one or more objects in the target window which indicates the object of interest is moving away from the camera.

FIGS. 6A-6B illustrates two examples of the size change of one or more objects in the target window which indicates the object of interest is moving closer to the camera.

FIG. 7 illustrates an exemplary analysis of the object motion of one object of interest in the target.

FIG. 8 illustrates an exemplary analysis based on extracted features in the target window.

FIG. 9 illustrates an example of the area change of image content of interest derived from the target window.

FIG. 10 illustrates an exemplary change of deformable object contour associated with the target window.

FIG. 11 illustrates an example of the size change of a selected region in the target window.

FIG. 12 illustrates an exemplary flow chart of an AF system incorporating an embodiment of the present invention.

### DETAILED DESCRIPTION OF THE INVENTION

Traditional object tracking provides information to the AF algorithm to track the target window or a selected region thereof to assist auto focusing. The information usually includes the designated target window only, such as the location and shape of the target window in the image. Based on the information, the AF algorithm performs original scan approaches and searches to find the focus peak in which the best position for focusing is located (focus position). However, the search for focus back and forth may limit the focus speed. In situations when the objects in the target window exhibit rapid change, quality of the image captured may be degraded significantly due to the incapability of tracking objects for AF.

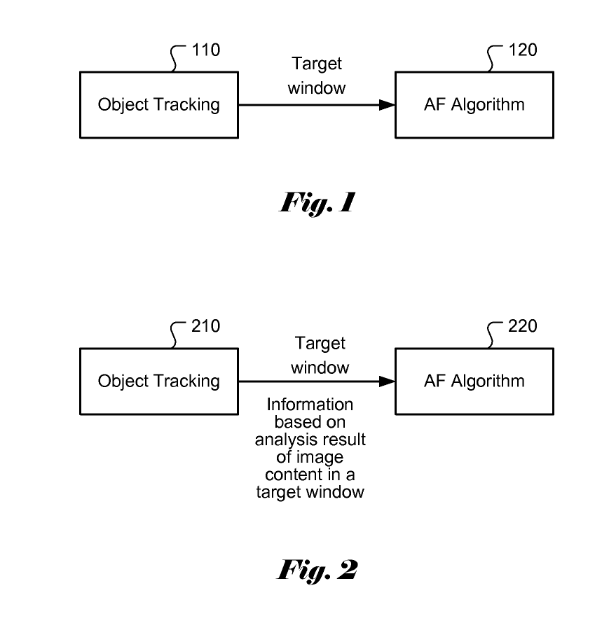

Therefore it is an objective of the present invention to provide an auto focusing method to improve the speed or quality of focusing. FIG. 2 illustrates a simplified AF method according to the present invention, comprising object tracking 210 and AF algorithm 220. Different from the conventional object tracking function, the object tracking of the present invention provides information based on the analysis of image content in the target window in addition to the target window to the AF algorithm to achieve better AF performance. The AF algorithm 220 then updates one or more camera parameters, such as camera focus, camera pan, camera tilt and camera zoom, based on the information.

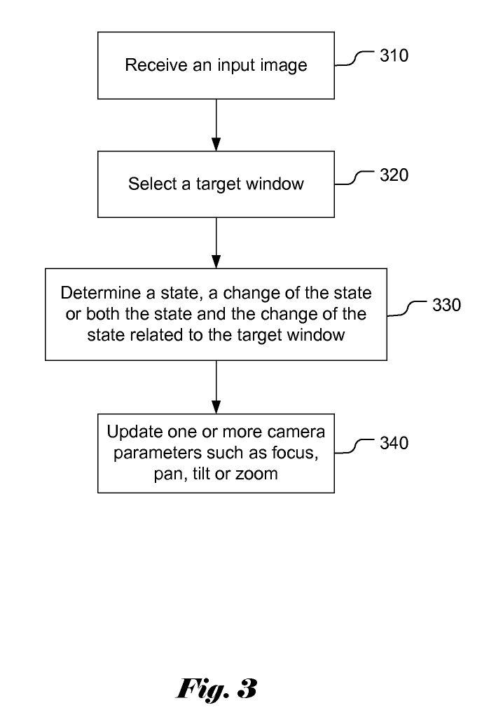

To accomplish the above mentioned objective, an AF method based on the analysis of the image content in a target window to determine a state, a state change or both the state and the state change related to a target window is disclosed, as shown by the flow chart in FIG. 3. The target window in the present invention may correspond to a rectangular area, a round or oval area, or any arbitrary shapes in this disclosure. Furthermore, the target window may correspond to un-connected areas. After a camera picks up an image by an optical subsystem, the image information is supplied to object tracking in step 310. When the camera operator selects a target window in step 320, the image is processed by object tracking to extract a target window from its background and locate the position. Then a state, a change of the state or both the state and the change of the state of the target window are determined in step 330 by analyzing the image content in the target region. The information associated with the state, the change of the state or both related to the target window is used by the AF algorithm to control focusing in step 340 or adjust other camera parameters such as zoom, pan, tilt, etc. The state can be the size, position or pose of one or more objects in the target window. It can also be the size, position, pose or other information of a selected region, such as the region having same characteristic in image attributes (like color, texture or gradient), in the target window. The state can also be behavior or gesture of one or more objects in the target window, such as movement direction, rotating body, turning around and shaking hand. The state can also be features extracted from the target window or scales associated with one or more objects in the target window, optical flow or motion field associated with the target window, description of the image content of interest derived from the target window, or one or more segmented regions or deformable object contour associated with the target window. In additional to the target window information, other computer vision information, image processing information, video processing information or pattern recognition information also can be provided for the AF algorithm to improve the focus speed of a camera.

By determining a state, a state change or both based on the analysis of the image content in the target window, the relative movement between the object of interest and the camera can be estimated and be used for focusing or adjusting other camera parameters. When the distance between an object of interest and a camera changes, the size of the object in the image becomes bigger or smaller correspondingly. Therefore, the size change of one or more objects in the target window is an indication of the search direction for the next focus peak. Furthermore, the size change of the objects can also be used as an initial guess of the number of steps to search for next focus peak by the AF algorithm.

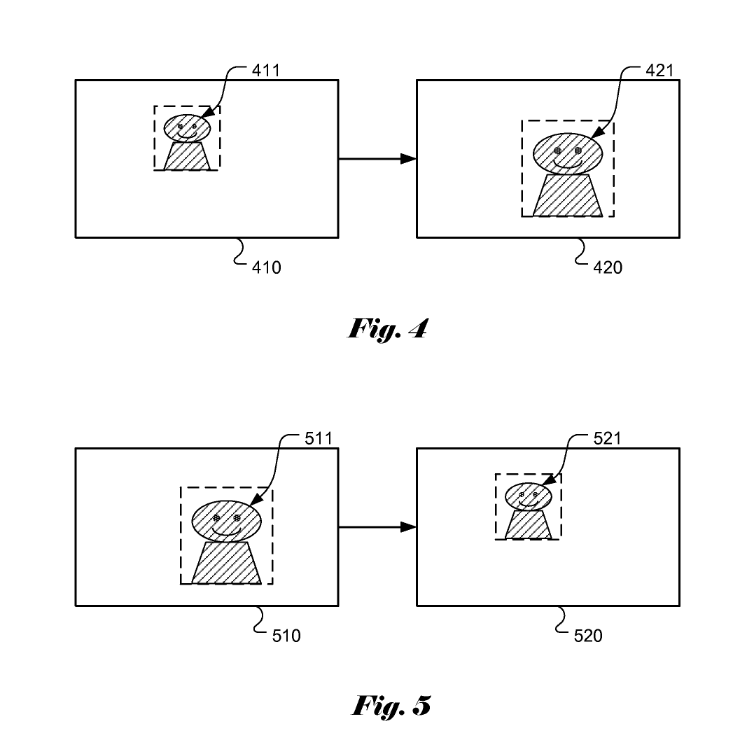

The image size change trend (to be bigger or smaller) of one or more objects analyzed can be supplied to the AF algorithm to control the camera focus searching direction moving backward to Macro or forward to Infinity. For example, when the size of object 421 in the next image frame 420 is bigger than that of object 411 in image frame 410 as shown in FIG. 4, this indicates that the object is moving closer to the camera. Therefore, the focus of the camera should move toward Macro. According to the present invention, the information that updates the focus toward Macro together with the target window information is provided to the AF algorithm. On the other hand, when the object moves farther away from the camera, the size of the object 511 in image frame 510 becomes smaller in the next image frame 520 as shown by object 521 in FIG. 5. Therefore, when the size of the object in the target window becomes smaller, the focus of the camera should be moved toward Infinity. The analysis result together with the target window information is supplied to the AF algorithm to update the camera focus toward Infinity.

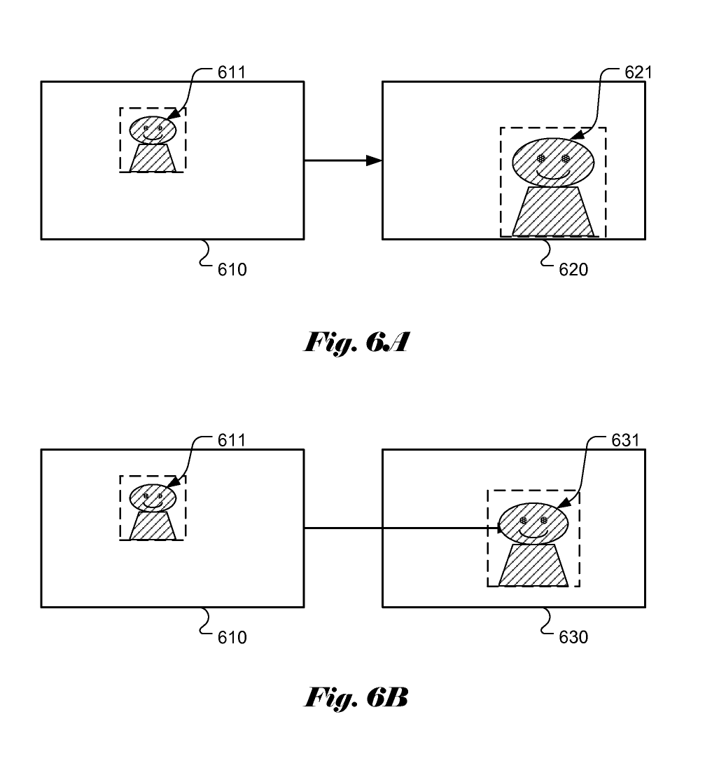

The determination of the size, the size change or both of one or more objects in a target window can also provide the information for the step size of focusing. The size and the size change of the object reflect the distance and distance change between the object and the camera. Thus the determination or analysis of the size and the size change can provide information for the AF algorithm to estimate the steps for finding focus peak. For example, the size change of object 610 in FIG. 6A is bigger than that in FIG. 6B. This indicates that the distance change in FIG. 6A is bigger than that in FIG. 6B. If the number of focusing steps in FIG. 6A is M and the number of focusing steps in FIG. 6B is N, then M is greater than N according to an embodiment of the present invention. The search direction (the focus should be updated toward Macro) and the estimated number of focusing steps are both provided to the AF algorithm for finding focus peak.

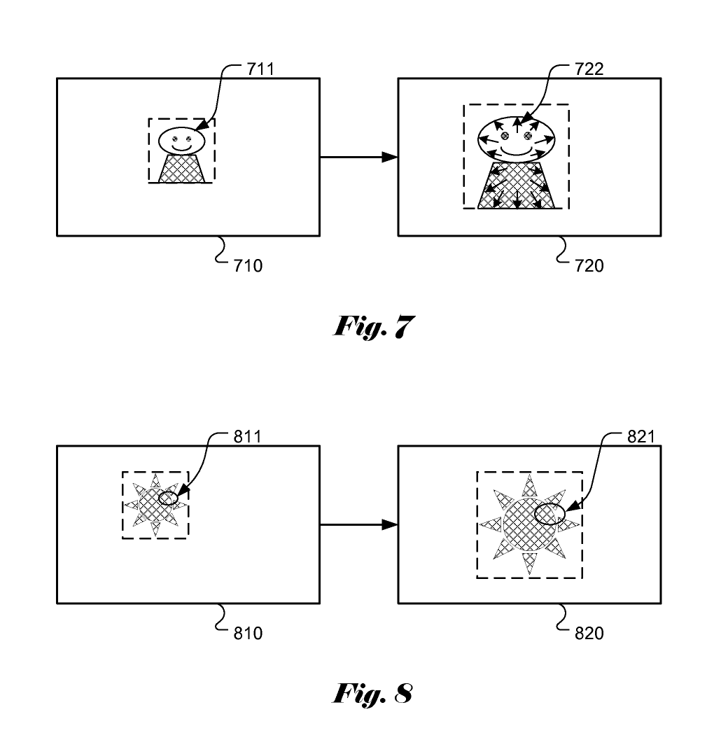

Besides object tracking based on the size, the size change or both of one or more objects in the target window, optical flow or motion field associated with the target window or object motion of one or more objects in the target window can also be used to determine a state, a change of state or both of one or more objects. According to one embodiment, image content is analyzed for determining object motion associated with one object, or determining optical flow or motion field associated with the object(s) in the target window or associated with the target window to provide information for focusing. Such as the example shown in FIG. 7, the motion of object 711 is determined by analyzing object 711 in frame 710 and the next image frame 720 and the motion is shown by the arrows group 722. The object motion in FIG. 7 indicates object 711 is moving closer to the camera. Therefore, the information associated with optical flow or motion field associated with the target window or object motion of one or more objects in the target window is provided for the AF algorithm to update focus toward Macro.

While, in some situations, to determine the state, the state change or both of one or more objects in the target window may incur high computational cost which decelerates focusing speed, to analyze image content with optical flow or motion field may also incur high computational cost or generate wrong results for object tracking In order to speed up focusing speed of a camera in such situations, an embodiment according to the present invention determines a state, a state change or both by analyzing certain features extracted from the target window or scales associated with one or more objects in the target window. By analyzing extracted features or estimating the scale change (such as gradient change, edge change, or texture change, etc.) of one or more objects in the target window, the relative movement between the object of interest and the camera can be estimated for AF. For example shown in FIG. 8, when the object in image frame 810 moves closer to the camera, the extracted features 821 in the next image frame 820 (or the scale of the extracted features) in the target window can be analyzed to get the indication of the movement direction comparing to the extracted features 811 obtained from previous image frame. Then, the analysis result of these two image frames which indicates the object moving closer can be provided for the AF algorithm to update the camera focus toward Macro. On the contrary, the camera focus is updated toward Infinity accordingly when the analysis result of the extracted features in the target window indicates that the object is moving farther. In addition to the analysis based on the scales of extracted features, the analysis based on the scales associated with one or more objects in the target window can also be used to find focus peak.

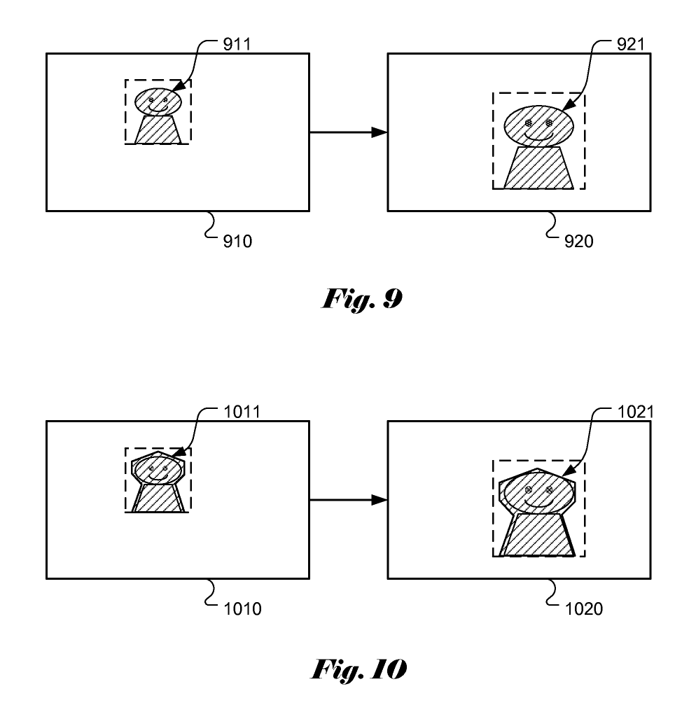

In one embodiment of the present invention, description of the image content of interest derived from the target window is analyzed to determine the state, the state change or both related to the target window for focusing. The description of the image content of the same characteristics can be represented by image attributes, such as color, texture or gradient. The areas in two frames having the same image attributes can be used for AF control. For example, area 911 of frame 910 has the same characteristic as area 921 of next frame 920 and the corresponding area sizes are Al and A2 respectively as shown in FIG. 9. If A2 of area 921 is greater than Al of area 911, it implies that the target object is moving closer to the camera. Therefore, the information of the analysis based on the description of the image content can be used to update focus toward Macro. On the other hand, if A2 is less than A1 which indicates the target object is moving farther from the camera, the camera focus is updated toward Infinity.

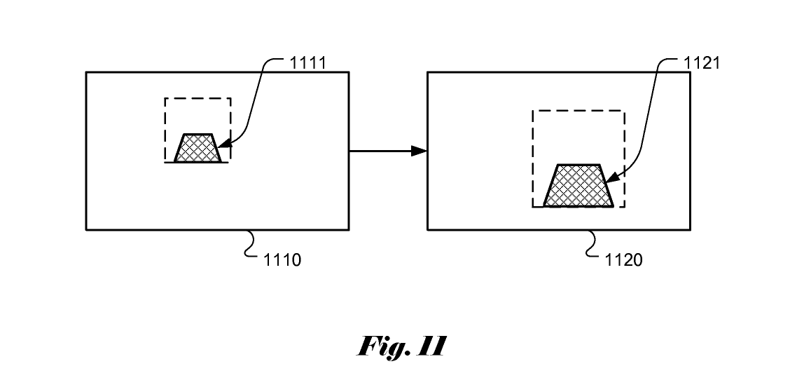

According to one embodiment of the present invention, determining a state, a state change or both can also be based on the analysis of one or more segmented regions or deformable object. The regions or deformable objects in an image can be determined using known segmentation techniques such as region growing (region-based segmentation) or active contour model (also called snake). As shown by the example in FIG. 10, the analysis result of the deformable object contour 1011 in frame 1010 and the deformable object contour 1021 in the next image frame 1020 indicates the object represented by the deformable object contour is moving closer to the camera. The information can be provided for the auto focus to update toward Macro. On the other hand, if the segmented region(s) or the deformable object(s) indicate that the object(s) is/are moving away from the camera, the information can be provided for the auto focus to update toward Infinite. While region growing or active contour model are used in the examples of region segmentation, other techniques may also be used.

In order to reduce the computational cost, determining a state, a state change or both related to the target window can also be based on one or more selected regions in the target window instead of determination based on the target window. In one embodiment according to the present invention, a selected region in the target window is detected and then a state, a state change of this selected region, or both are determined during object tracking to provide information for focusing. FIG. 11 illustrates an example of detecting a region in the target window, where region 1111 is detected in frame 1110 and region 1121 is detected in frame 1120. The area of region 1121 is larger than the area of region 1111. The larger area associated with region 1121 indicates that the region is moving toward the camera. Accordingly, the camera focus should be updated toward Macro. While one region is illustrated in FIG. 11, multiple regions may also be used. The multiple regions may be un-connected or partially connected. The region or regions may be associated with the target window or one or more objects in the target window. While analysis of the area change of the selected region is only one example to determine a state, a change of the state or both related to the selected region or regions in the target window, other methods may also be used.

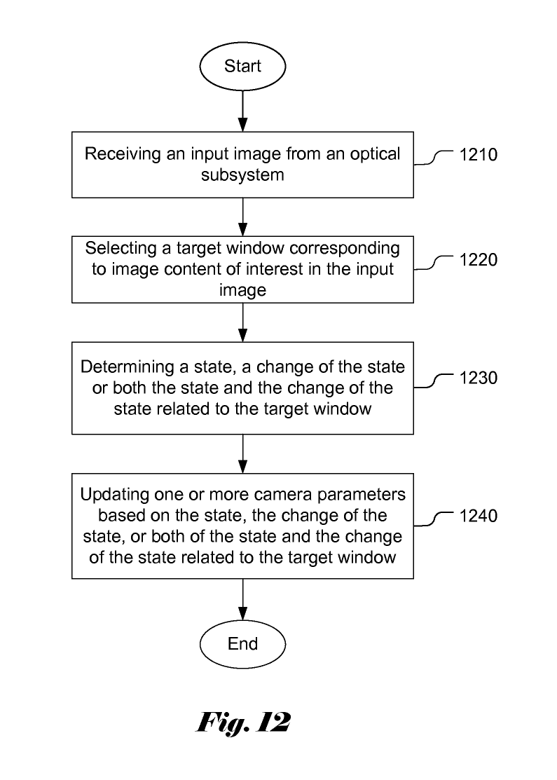

FIG. 12 illustrates an exemplary flow chart of an AF system incorporating an embodiment of the present invention. The process starts with receiving an input image from the optical subsystem as shown in step 1210. The target window corresponding to the image content of interest is then selected in step 1220 and supplied to the AF algorithm. To improve auto focusing performance, the image content in the target window is analyzed to determine a state, a state change or both related to the target window in step 1230. Based on the information of the state, the state change or both related to the target window, one or more camera parameters are updated in step 1240. Each of the methods used to determine the state, the state change or both as disclosed above can be considered as one of the object tracking algorithms. The methods disclosed in the above embodiments or examples can be combined. The methods used to determine a state, a state change or both as disclosed above can also be used in other AF functions other than object tracking. While FIG. 12 illustrates an exemplary flow chart according to one embodiment to practice the present invention, a skilled person in the art may rearrange the steps to practice the present invention without departing from the spirit of the present invention. For example, the step associated with determining which method or methods to be used to determining the state, the change of the state or both can be added to the flow chart.

The present invention may also be embodied in other specific forms without departing from its spirit or essential characteristics. The described examples are to be considered in all respects only as illustrative and not restrictive. The scope of the present invention is therefore, indicated by the appended claims rather than by the foregoing description. All changes which come within the meaning and range of equivalency of the claims are to be embraced within their scope.

1. A method of auto focusing for a camera, the method comprising:
receiving an input image formed by an optical subsystem of the camera;
selecting a target window corresponding to image content of interest in the input image;
determining a state, a change of the state, or both of the state and the change of the state related to the target window; and
updating one or more camera parameters based on the state, the change of the state, or both of the state and the change of the state related to the target window.

2. The method of claim 1, wherein said determining the state, the change of the state, or both of the state and the change of the state is based on a selected region of the target window.

3. The method of claim 1, wherein the state corresponds to size, position or pose of one or more objects in the target window.

4. The method of claim 1, wherein the state corresponds to area of one or more regions associated with the target window or one or more objects in the target window.

5. The method of claim 1, wherein the state corresponds to behavior or gesture of one or more objects in the target window.

6. The method of claim 5, wherein the behavior or gesture comprises movement direction, rotating and shaking hand.

7. The method of claim 1, wherein said one or more camera parameters comprises camera focus, camera pan, camera tilt and camera zoom.

8. The method of claim 7, wherein the camera focus is updated toward Macro if the state, the change of the state, or both of the state and the change of the state indicates one or more objects are moving closer to the camera, wherein the state is associated with said one or more objects in the target window.

9. The method of claim 7, wherein the camera focus is updated toward infinity if the state, the change of the state, or both of the state and the change of the state indicates one or more objects are moving farther from the camera, wherein the state is associated with said one or more objects in the target window.

10. The method of claim 7, wherein the state corresponds to size, position or pose of one or more objects in the target window.

11. The method of claim 10, wherein the camera parameters further comprises a focusing step associated with the camera focus and a number of focusing steps is selected depending on the state, the change of the state or both the state and the change of the state.

12. The method of claim 11, wherein a first number of focusing steps is selected for a first change size associated with a first state, a first change of state or both the first state and the first state of change, and a second number of focusing steps is selected for a second change size associated with a second state, a second change of state or both the second state and the second change of state, wherein the first number of focusing steps is larger than the second number of focusing steps if the first change size is larger than the second change size.

13. The method of claim 7, wherein the state corresponds to object motion associated with one or more objects in the target window, or optical flow or motion field associated with the target window or said one or more objects in the target window.

14. The method of claim 7, wherein the state corresponds to features extracted from the target window or scales associated with one or more objects in the target window.

15. The method of claim 7, wherein the state corresponds to description of the image content of interest derived from the target window.

16. The method of claim 7, wherein the state corresponds to an area of one or more segmented regions or deformable object contours associated with the target window or one or more objects in the target window.

17. The method of claim 16, wherein said one or more segmented regions or deformable object contours are determined based on region growing or active contour model.

18. An apparatus of auto focusing for a camera, the apparatus comprising:
means for receiving an input image formed by an optical subsystem of the camera;
means for selecting a target window corresponding to image content of interest in the input image;
means for determining a state, a change of the state, or both of the state and the change of the state related to the target window; and
means for updating one or more camera parameters based on the state, the change of the state, or both of the state and the change of the state related to the target window.

19. The apparatus of claim 18, wherein said means for determining the state, the change of the state, or both of the state and the change of the state is based on a selected region of the target window.

20. The apparatus of claim 18, wherein the state corresponds to size, position or pose of one or more objects in the target window.

21. The apparatus of claim 18, wherein the state corresponds to area of one or more regions associated with the target window or one or more objects in the target window.

22. The apparatus of claim 18, wherein the state corresponds to behavior or gesture of one or more objects in the target window.

23. The apparatus of claim 18, wherein said one or more camera parameters comprises camera focus, camera pan, camera tilt and camera zoom.
